(19) United States
(12) Patent Application Publication
(10) Pub. No.: US 2007/0095680 A1
(43) Pub. Date: May 3, 2007

(54) Continuous positive airway pressure (CPAP) bag

(76) Inventors: Inna Spektor, Niskayuna, NY (US); Nancy Gold, Niskayuna, NY (US); Paul G. Martin, Cohoes, NY (US); Ronald A. Dingman, Schenectrady, NY (US)

Correspondence Address: NANCY GOLD;TAUGH TRAVELER LTD, 1012 STATE ST., SCHENECTADY, NY, 12307, US

(21) Appl. No.: 11/261,180

(22) Filed: Oct. 27, 2005

(51) Int. Cl. B65D 81/24; B65G 65/00; B65G 1/00

(52) U.S. Cl. 206/210; 414/322; 206/803

(57) ABSTRACT

The present continuous positive airway pressure machine bag invention is a bag that will allow emergency personnel to have the CPAP machines at hand, transportable, and easily and quickly accessible and protected. While the present CPAP machine bag invention is sized to fit a specific CPAP machine, it is thought that this invention will either fit other machines or will be adaptable or modifiable to fit other machines. The web grab handle, the ribbon handle at the zipper pulls, the two handles, the removable shoulder strap, and the extension of the tongue add to the convenience and importance of the invention, which may even be useful to non-emergency personnel or to emergency personnel for other gear or usage.

### CROSS REFERENCE TO RELATED APPLICATIONS

We have applied for a design patent for the design. We have also applied for a utility patent application for the outside including an inside different from the present patent application; the inside of the present invention is configured differently intended specifically for a different use.

### STATEMENT REGARDING FEDERALLY SPONSORED RESEARCH AND DEVELOPMENT

This invention did not have federally sponsored research and design.

### REFERENCE TO SEQUENCE LISTING, A TABLE, OR A COMPUTER PROGRAM LISTING APPENDIX

There is no appendix.

### BACKGROUND OF THE INVENTION

This continuous positive airway pressure (called CPAP) machine bag invention was conceived and developed to assist emergency and other personnel and persons when they are in situations requiring quick use of continuous positive airway pressure, which uses slightly pressurized air throughout the breathing cycle, so that breathing can be easier. These machines are important to emergency personnel in their assistance of injured people, and the machines require protection so they can be effective.

The CPAP machines may be carried in a pocket of another emergency response bag such as a duffel or an oxygen bag, or they may be carried separately in a duffel or other such independent bag or backpack. When they are carried in a pocket of another bag the size of the pocket may not be correct or the other items in the main portion of the bag may be overloaded, making the pocket smaller than intended. Also, the CPAP machines may be carried separately in a bag that has no protection and may not offer easy quick access to the machines. When carried in a bag without protection or with a too-small pocket—both of which might cause damage to the CPAP machine—and without offering easy, quick access to the machine, vital time may be lost in securing or retrieving the machine from a cramped space, or in opening the bag. Also, carrying the bag even in a non-specific padded bag may be cumbersome or hard to access the machine, or a non-specific bag might be confused with like bags or packs.

Currently there are no known bags to properly suit this need for CPAP machines to be carried protectively, with quick and easy access. There are many non-specific duffels, bags, or backpacks, as there are many non-specific padded bags without the proper attributes. Bags or packs containing CPAP machines may be kept ready in buildings or locations that house emergency resources, then carried by emergency personnel to the accident or other emergency. Sometimes these bags or packs are left in ambulances or other emergency vehicles until needed at the trauma scene. With the many items that emergency personnel are responsible for, it is imperative that the CPAP bags not be confused in bags with other items, or the CPAP machine be damaged, or awkward to carry, all of which are more likely with non-specific bags without quick-access, cumbersome bags or other containers or holders.

### BRIEF SUMMARY OF TIE INVENTION

The current continuous positive airway pressure (“CPAP”) bag invention provides emergency and other personnel a correctly-sized foam-padded, cloth material, bag for the CPAP machine, with easy quick access to that machine. Other features of the present CPAP bag invention include cloth-covered foam that curves protectively around the machine while leaving space for the accompanying hose(s) or tube(s), adjustable removable shoulder strap, top handles, end handle, double-zippered tongue opening, tongue handle, grab extension of the tongue, hook and loop sections, and reflective tape strips on all sides.

### BRIEF DESCRIPTION OF THE DRAWINGS

FIG. 1 Shows the closed top and one side of the CPAP bag invention,

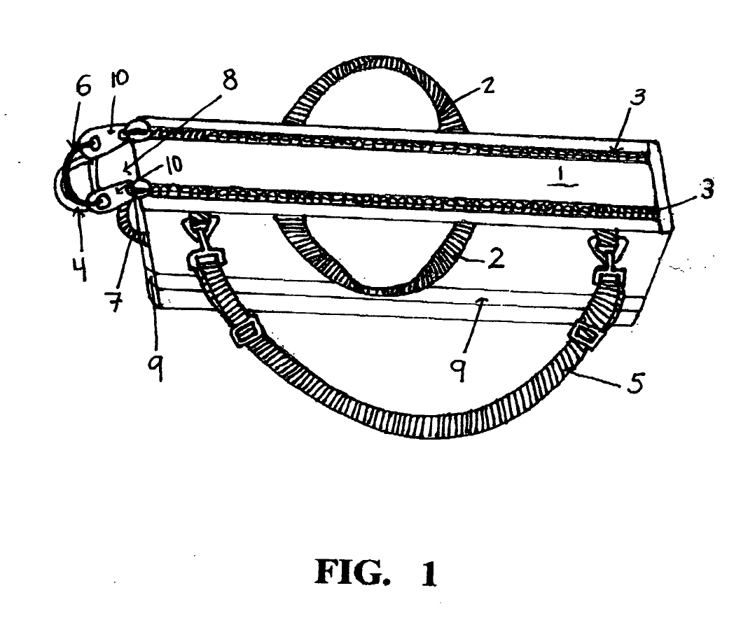

FIG. 2 shows the closed top and other side thereof,

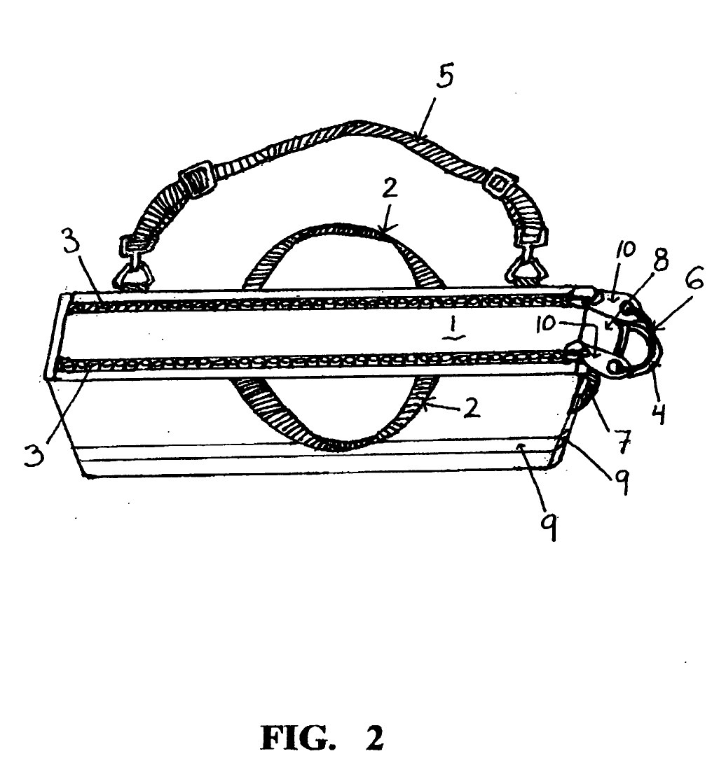

FIG. 3 shows the bottom,

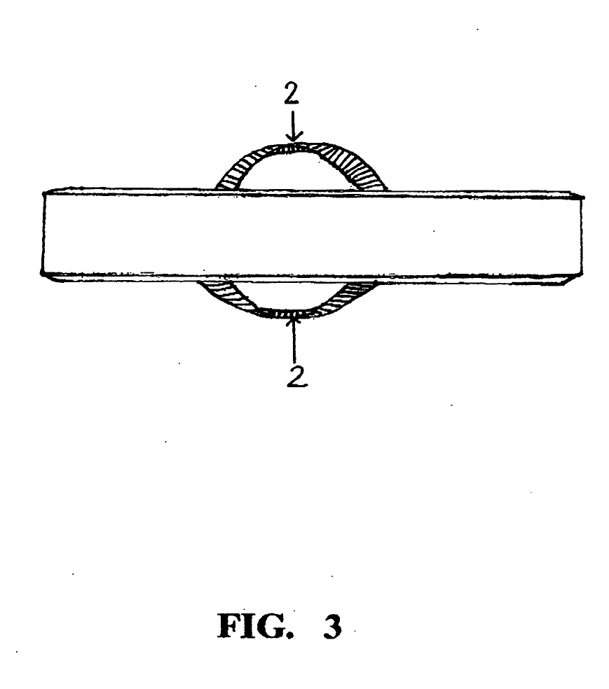

FIG. 4 shows one end,

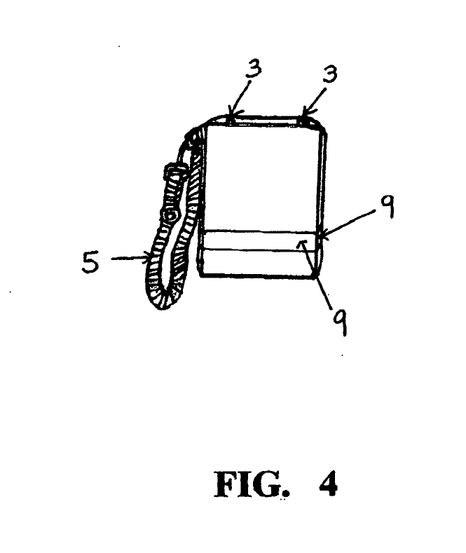

FIG. 5 shows the other end,

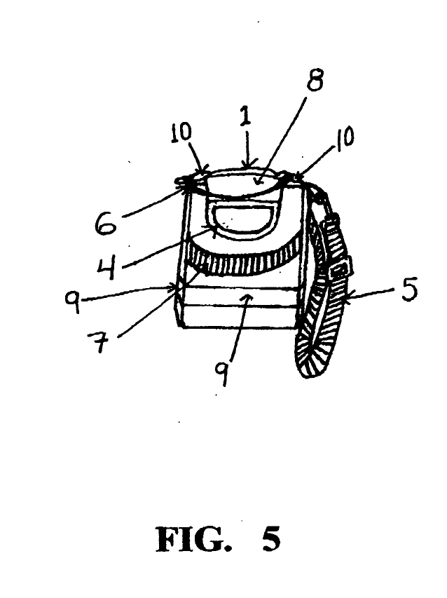

FIG. 6 shows the closed top,

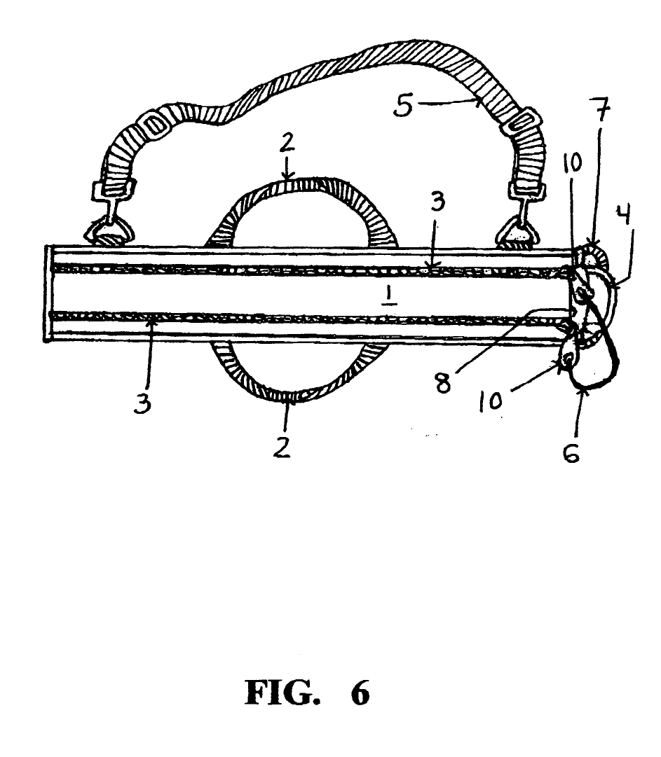

FIG. 7 shows the opened top,

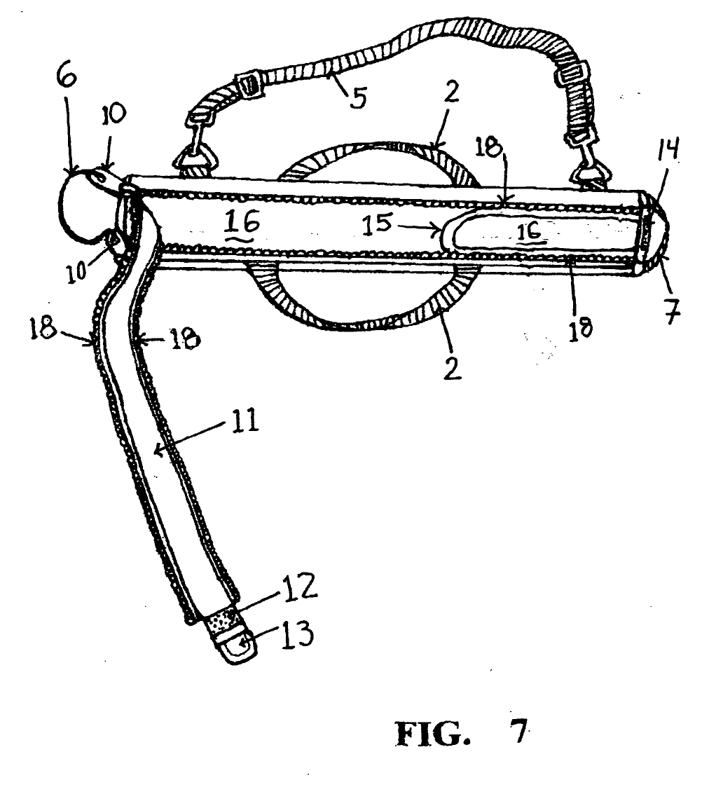

FIG. 8 shows the inside.

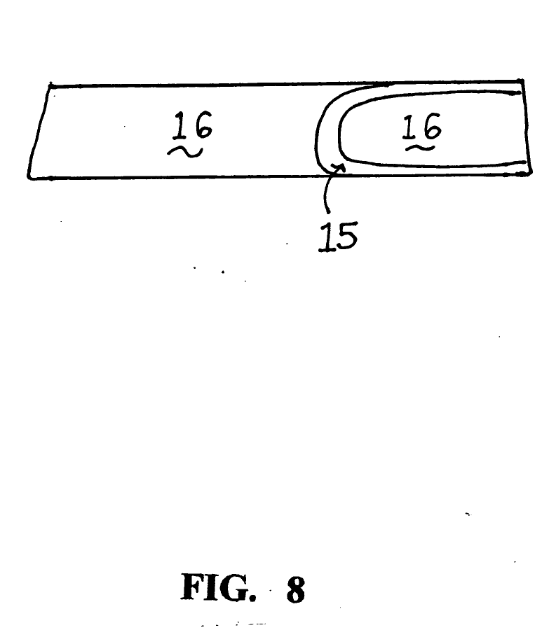

FIG. 9 Shows a person using one hand to grip the ribbon handle of the CPAP bag invention to open the bag, while using the other hand to grip the web end handle thereof,

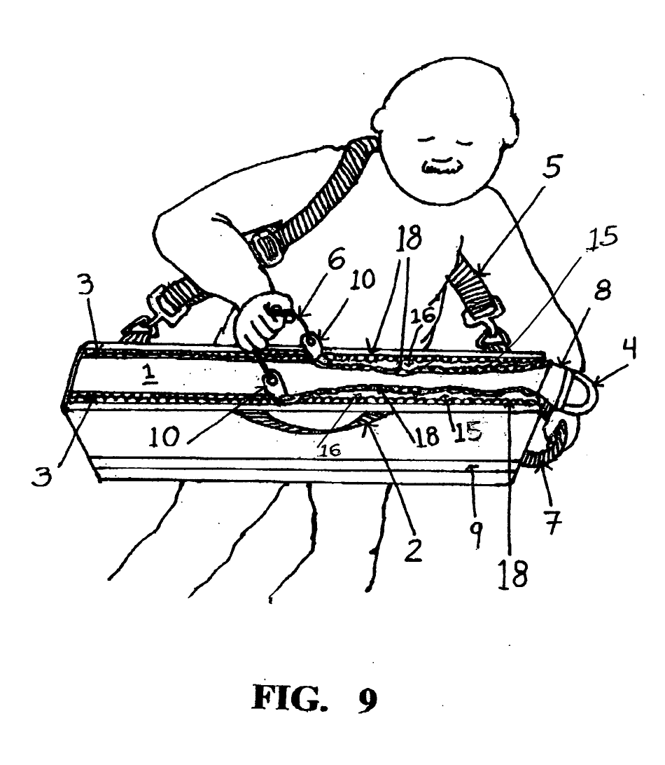

FIG. 10 shows a person using one hand to grip the grab-extension of the tongue to open the bag, while using the other hand to grip the web end handle.

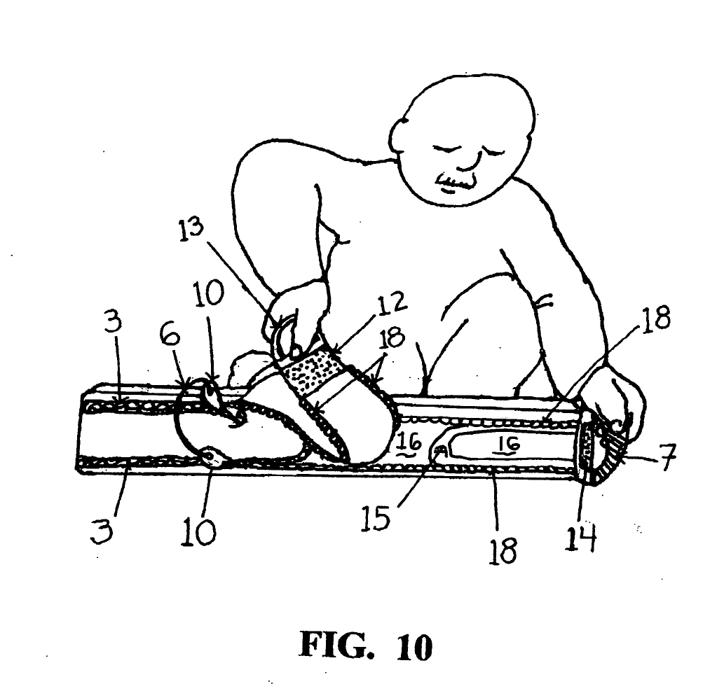

### DETAILED DESCRIPTION

The CPAP bag invention as shown has a tongue 1 (topside), 11 (underside) cover at the top; web handles 2 at the top; removable shoulder strap 5; zippers 3 (closed), 18 (open) on two sides at the top; a zipper pull 10 at each zipper 3; a ribbon 6 connecting the zipper pulls 10; a web grab handle 7 on one end; a grab extension 4 (topside), 13 (underside) of the tongue 1 (topside), 11 (underside); reflective tape strips 9 on the two sides and the two ends; hook and loop 14 at one end which corresponds with hook and loop 12 which is sewn to the underside of the web 8 at end of the tongue 1 (topside), 11 (underside).

The CPAP bag invention as shown has a cloth-covered foam-padded piece 15, with a different color cloth contrasting to the interior color of the bag to allow the quick finding of the machine in emergency situations; this protective piece also keeps the machine separate from the machine's hose(s) or tube(s), this way avoiding delays in emergency usages. The CPAP bag invention as shown has the zipper sides 18 split when the tongue 1 is open, when one can then also see the insides 16 of the bag in addition to the foam piece 15

Although it is thought that the present embodiment as described is the optimum embodiment for emergency personnel needs, alternative embodiments of this CPAP bag invention can be imagined by one practiced in the art. An example such as a backpack using detachable, hide-away, or integral shoulder straps may be imagined. Also, modifications such as backpack straps as described may be on the present invention. The cloth-covered foam piece may be removable. Modifications in the size of the invention and/or in the number of interior foam pieces may be made to accommodate different sizes or different quantities of CPAP equipment should the need arise. Different materials may be used, conceivably mesh netting or even an interior mesh pocket on the inside top of the bag; cord may be used instead of ribbon, and other material changes might be imagined. To simplify, there might be no handles, and to aggrandize there might be outer pockets for spare disposable gloves, tracheal equipment, and/or other emergency items. Reflective tape strips might be omitted or might take alternative forms, for example reflective threads or a hide-away reflective tape configuration. Alternatives to the tongue cover as used in the current embodiment might be either a slit opening, a hook and loop closure, a one-zipper opening, a quick-release buckle opening, or additional configurations as imaginable by one practiced in the art. An additional embodiment might be a two-zipper opening with one compartment below each zipper. The present embodiment of the CPAP bag invention could be sewn-on to another emergency equipment bag or otherwise attached, perhaps with quick release buckles, to such a bag or backpack, or the entire CPAP bag invention could be made to fit inside another bag or apparatus. While the present invention has been made specifically to solve the problem of protectively transporting and having quick access to the continuous positive airway pressure machines, it is conceivable that this invention will prove useful in other areas.

We claim:

1. A container comprising at least one compartment adapted to hold at least one continuous positive airway pressure machine.

2. The container of claim 1, including a shoulder strap.

3. The container of claim 1, including a handle.

4. The container of claim 1, further comprising at least one partition, whereby the at least one compartment is adapted to hold a continuous positive airway pressure machine.

5. The container of claim 1, further comprising a device for closing the at least one compartment.

6. The container of claim 1, wherein there is at least one foam-padded separation within the at least one compartment.

7. The container of claim 6, wherein the device includes at least one of the following: a zipper, a tongue cover, and hook and loop.

8. The container of claim 6, wherein the device includes at least one of the following: a cover and hook and loop.

9. The container of claim 6, wherein the device includes at least one of the following: a zipper, a tongue cover, hook and loop, and an extension piece on the tongue cover.

10. The container of claim 6, wherein the device includes at least one of the following: a zipper, a tongue cover, hook and loop, an extension piece on the tongue cover, and a grab handle on the opposing end of the container.

11. The container of claim 6, wherein the device includes at least one of the following: a zipper, a tongue cover, hook and loop, and a grab handle connected to a zipper pull.

12. The container of claim 6, wherein the device includes at least one of the following: a tongue cover, hook and loop, and an extension piece on the tongue cover.

13. The container of claim 6, wherein the device includes at least one of the following: a cover and a quick-release buckle.

14. The container of claim 6, wherein the device consists of a cover and elastic.
